(19) United States
(12) Patent Application Publication
(10) Pub. No.: US 2019/0112042 A1
(43) Pub. Date: Apr. 18, 2019

(54) LIFTING BODY VTOL AIRCRAFT

(71) Applicant: John Mueller, Scottsdale, AZ (US)

(72) Inventor: John Mueller, Scottsdale, AZ (US)

(21) Appl. No.: 16/149,001

(22) Filed: Oct. 1, 2018

Related U.S. Application Data
(60) Provisional application No. 62/572,984, filed on Oct. 16, 2017.

(51) Int. Cl. B64C 29/00; B64C 39/10; B64D 27/20; B64D 33/04

(52) U.S. Cl. CPC B64C 29/0066; B64D 33/04; B64D 27/20; B64C 39/10

(57) ABSTRACT

A VTOL aircraft has a substantially delta-shaped lifting body fuselage with airfoils disposed along all three sides. In vertical flight mode the airfoils act as exhaust diverters. A flow of exhaust gas flows from a centrally located vertical flight gas diffuser over the top surface of the lifting body and then is directed downward by the airfoils to provide vertical lift. In vertical flight mode, the entirety of the exhaust from the engine is diverted to the vertical flight gas diffuser by means of a transition duct that diverts the flow of gas through a 90° upward bend into the vertical flight gas diffuser. In horizontal flight mode the transition duct is fully retracted to permits the entirety of the engine thrust to be directed rearward to propel the aircraft in a horizontal flight mode.

### BACKGROUND OF THE INVENTION

This invention relates generally to aircraft and, in particular to vertical take-off and landing aircraft.

Aircraft that are capable of vertical take-off and landing fall generally into two categories. The first category consists of those with relatively low propulsive efficiency and high top speed such as the F 35 joint strike fighter and the Hawker Harrier. Because of the relatively low propulsive efficiency during vertical takeoff and landing attributable to the high-speed exhaust of their jet engines, these aircraft require a very large power to weight ratio to achieve vertical flight. The second category consists of aircraft with relatively high propulsive efficiency such as helicopters. Although helicopters are more efficient and can fly vertically with a much lower power to weight ratio, helicopters have a relatively low maximum top speed attributable to the need to prevent the advancing blade from entering the trans-sonic flight regime. Accordingly, what is needed is an aircraft having relatively high propulsive efficiency during vertical takeoff associated with a relatively modest exhaust speed while maintaining the ability to achieve supersonic flight in a horizontal flight mode.

### SUMMARY OF THE INVENTION

The present invention solves the foregoing problem by providing a jet engine powered lifting-body vertical take-off and landing (VTOL) aircraft. In an illustrative embodiment, the fuselage of the lifting-body comprises a substantially triangular or delta-shaped lifting body having airfoils disposed along all three sides. In vertical flight mode the airfoils act as exhaust diverters. A flow of exhaust gas flows from a centrally located vertical flight gas diffuser over the top surface of the lifting body and then is directed downward by the airfoils to provide the vertical lift necessary for vertical take-off. In horizontal flight mode, the airfoils act as canards and ailerons in cooperation with a conventional tail that includes vertical and horizontal stabilizers, elevators and a rudder.

Power for both vertical and horizontal flight is provided by a conventional jet engine, preferably a high-bypass turbofan engine, attached below the fuselage. In vertical flight mode, the entirety of the exhaust from the engine is diverted to the vertical flight gas diffuser by means of a transition duct that sealingly engages the exhaust outlet of the engine and diverts the flow of gas through a 90° upward bend into the vertical flight gas diffuser. The exhaust gas within the transition duct powers a multi-stage turbine that slows and cools the exhaust gas before entering the vertical flight gas diffuser. Power from the turbine is used to draw additional air into the vertical flight gas diffuser to further augment the volume while reducing the temperature of the exhaust gas exiting the vertical flight gas diffuser. The transition duct itself is movable from a first position in which it diverts the entirety of the engine exhaust into the vertical flight gas diffuser to a second position in which it partially obstructs and therefore diverts a portion of the engine exhaust into the vertical flight gas diffuser and finally to a third position in which it is fully retracted which permits the entirety of the engine thrust to be directed rearward to propel the aircraft in a horizontal flight mode.

### BRIEF DESCRIPTION OF THE DRAWING

The present invention will be better understood from a reading of the following detailed description, taken in conjunction with the accompanying drawing figures in which like references designate like elements and, in which:

FIG. 1 is a front perspective view of a lifting body VTOL aircraft incorporating features of the present invention;

FIG. 2 is a top view of the aircraft of FIG. 1;

FIG. 3 is a cross-sectional view detailing the propulsion system of the aircraft of FIG. 1 in a first fully-deployed position;

FIG. 4 is a cross-sectional view of the propulsion system of FIG. 3 in a second partially-retracted position; and

FIG. 5 is a cross-sectional view of the propulsion system of FIG. 3 in a third fully-retracted position.

### DETAILED DESCRIPTION

The drawing figures are intended to illustrate the general manner of construction and are not necessarily to scale. In the detailed description and in the drawing figures, specific illustrative examples are shown and herein described in detail. It should be understood, however, that the drawing figures and detailed description are not intended to limit the invention to the particular form disclosed, but are merely illustrative and intended to teach one of ordinary skill how to make and/or use the invention claimed herein and for setting forth the best mode for carrying out the invention.

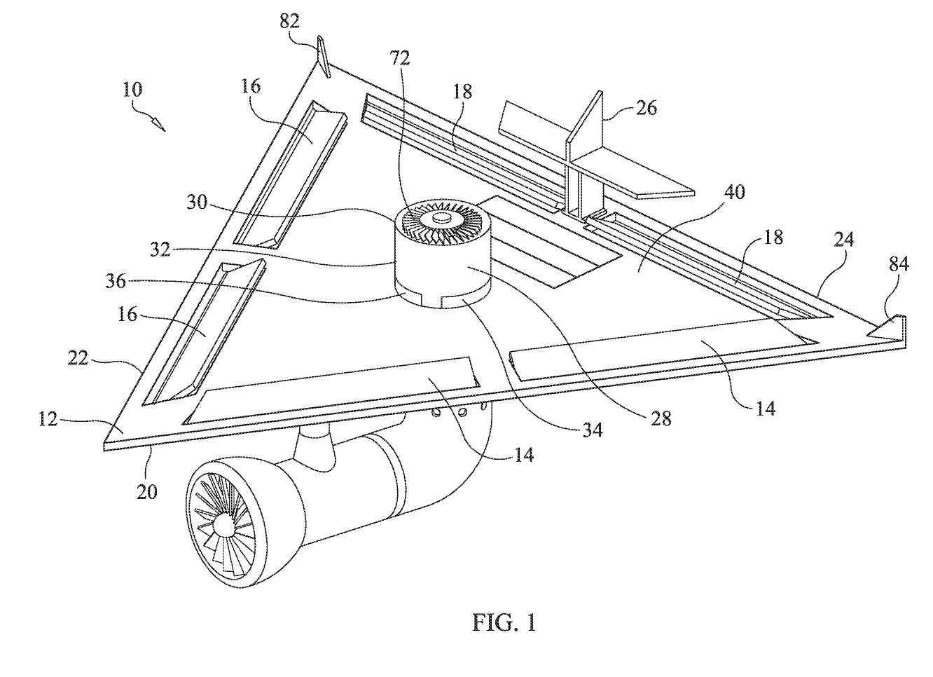

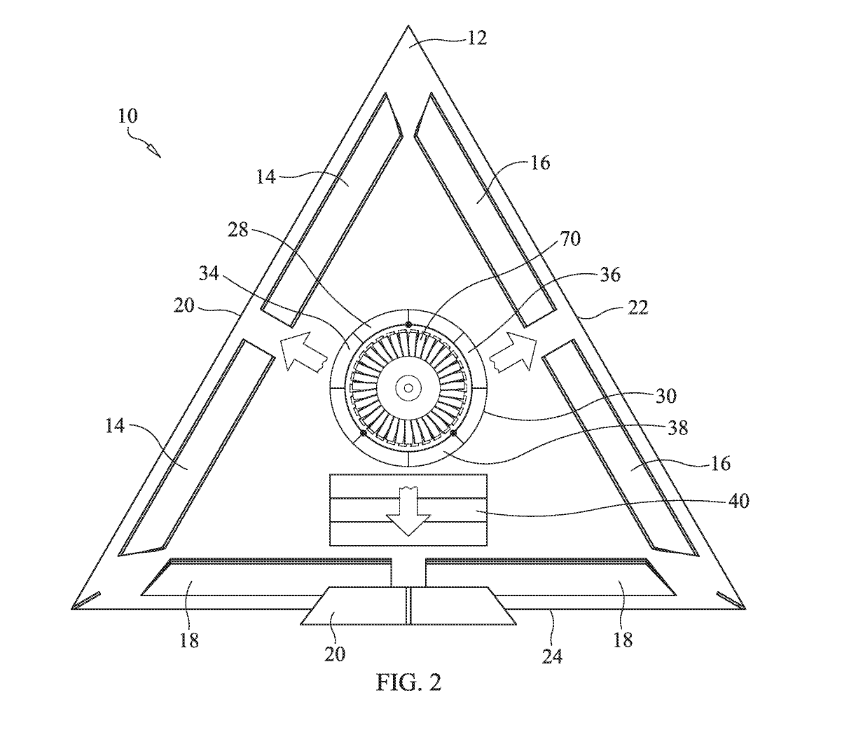

With reference to the figures, and in particular FIGS. 1 and 2, a delta body vertical takeoff and landing (VTOL) aircraft 10 in accordance with the present invention comprises a fuselage 12, which in plan view has a substantially triangular shape, preferably the shape of an isosceles triangle and most preferably the shape of an equilateral triangle. The fuselage 12 may be fabricated from any appropriate lightweight material including aluminum, titanium, carbon fiber or the like. Airfoils 14, 16, 18 are arranged, one each, along the sides 20, 22, 24 of the fuselage. As described more fully hereinafter, airfoils 14, 16, 18 act as ailerons in horizontal flight mode and act as flow diverters in vertical flight mode.

A conventional tail assembly 26 comprising a horizontal stabilizer, vertical stabilizer, elevators and rudder for use in horizontal flight mode extends from side 24 of the fuselage. As explained more fully hereinafter, fuselage 12 further comprises a vertical flight gas diffuser 28, which comprises a cylindrical duct 30 having a centrally mounted compressor section 32 and a plurality of laterally-facing exhaust apertures 34, 36, 38.

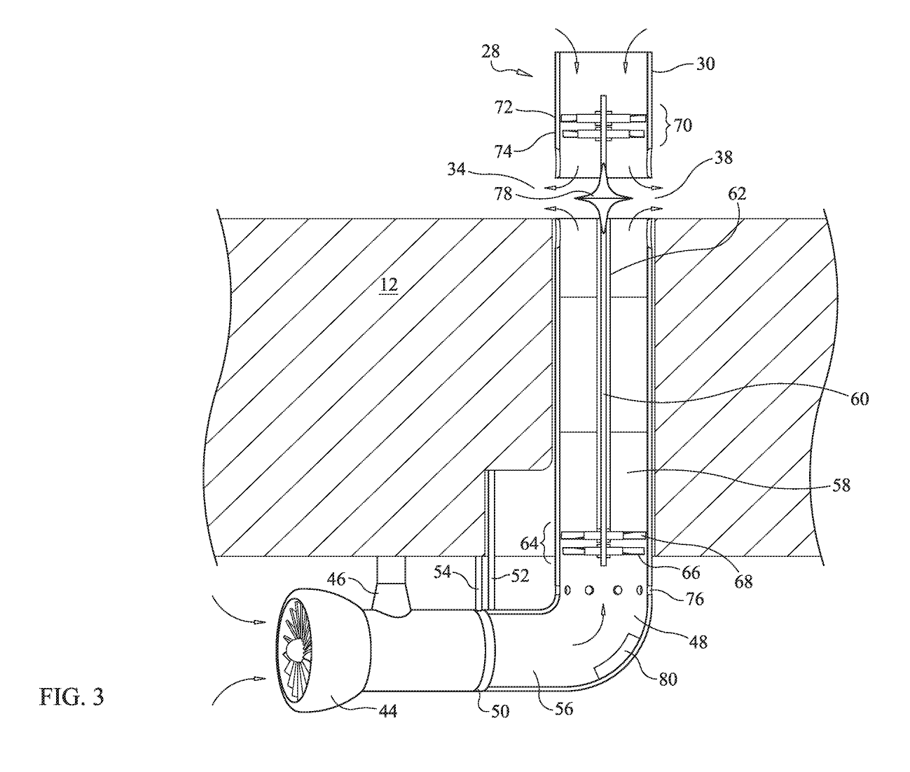

With additional reference to FIG. 3, which shows aircraft 10 in vertical flight mode, in the illustrative embodiment, power for both vertical and horizontal flight is provided by a single high-bypass turbo fan engine 44, such as a General Electric GE90 high-bypass turbofan aircraft engine having a thrust rating of at least 360 kN. Although in the illustrative embodiment a single high-bypass turbofan aircraft engine is employed, use of multiple high-bypass or low-bypass turbofan aircraft engines may be advantageously employed within the scope of the invention and, therefore, the invention disclosed herein is not limited to a single high-bypass engine. Engine 44 is supported by a pylon 46 which extends underneath fuselage 12. In vertical flight mode, the output from engine 44 is directed entirely into vertical flight gas diffuser 28 by a transition duct 48 which engages and is sealed with the exhaust outlet 50 of engine 44. Transition duct 48 is preferably constructed of a high temperature superalloy and may include bleed air orifices fed by the compressor section of engine 44 to maintain gas temperatures within transition duct 48 at acceptable levels, and/or may have a ceramic thermal barrier coating to enable transition duct 48 to withstand the extreme gas temperatures. Optionally, cooling baffles 72 may be located in areas of highest temperature in transition duct 48. In order to ensure a gas-tight seal and to reduce the reaction loads on transition duct 48, transition duct 48 includes a vertical sliding track member 52 that engages a corresponding vertical track 54 at the exhaust outlet 50 of engine 44.

Gas entering transition duct 48 is directed from the horizontal portion 56 of transition duct 48 through a 90° bend, into the vertical section 58 of transition duct 48, then into vertical flight gas diffuser 28. As the gas enters vertical section 58 of transition duct 48 it passes through a multi-stage axial turbine 64 comprising at least two counter-rotating turbine disks 66, 68 which, for reasons that will be more fully explain hereinafter, are mounted on telescoping shafts 60, 62. Shafts 60, 62 in turn power a multi-stage axial compressor 70 comprising at least two counter-rotating compressor wheels 72, 74. Compressor 70 draws air into vertical flight gas diffuser 28 to augment and reduce the temperature of the high-temperature gas from transition duct 48. This combined airflow is then directed radially outward from vertical flight gas diffuser 28 through exhaust apertures 34, 36, 38. A flow diverter 76 comprising a paraboloid body of revolution assists in redirecting the flow with minimal losses. The combined airflow exiting through exhaust apertures 34, 36, 38 flows outward over the top of fuselage 12 where it is directed downward by airfoils 14, 16, 18 as shown in FIG. 1. Passing the gas stream from engine 44 through axial turbine 64 has the effect of slowing and cooling the gas stream as work is extracted. Slowing the gas stream also improves the kinetic efficiency of the gas steam as it exits exhaust apertures 34, 36, 38 into the relatively stationary air surrounding vertical flight gas diffuser 28. Flow through exhaust apertures 34, 36, 38 may be throttled to control stability by any conventional means such as variable aperture nozzles. Additional flight stability in vertical flight mode is provided by a plurality of reaction jets 76, which comprise a radial array of nozzles in transition duct 48 which may be selectively opened or closed to provide additional stability control.

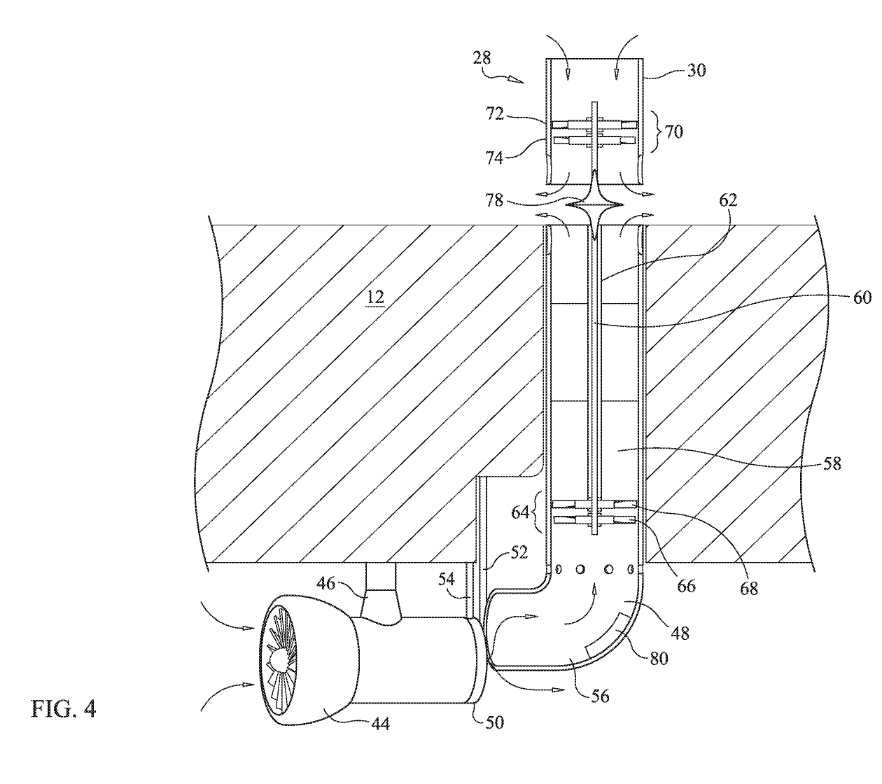

With additional reference to FIG. 4, aircraft 10 transitions from vertical flight mode to horizontal flight mode initially by withdrawing transition duct 48 partially upwards into fuselage 12. This enables a portion of the exhaust from engine 44 to be directed horizontally rather than the entirety of the exhaust entering transition duct 48. The portion of exhaust from engine 44 that does enter transition duct 48 continues to provide lift via vertical flight gas diffuser 28 as described hereinbefore. The portion of exhaust from engine 44 that does not enter transition duct 48 provides horizontal thrust for the purpose of transitioning to horizontal flight.

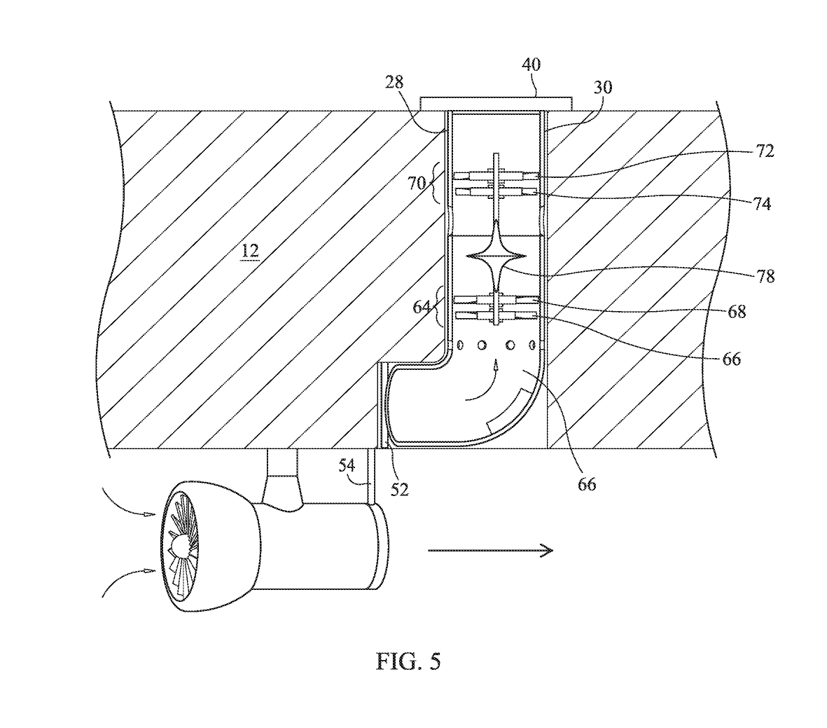

With additional reference to FIG. 5, after sufficient forward velocity has been attained for stable horizontal flight, aircraft 10 assumes a fully horizontal flight mode by withdrawing transition duct 48 fully into fuselage 12. Thereafter, aircraft 10 operates as a relatively conventional aerodynamic lifting-body aircraft with airfoils 14, 16 acting as canards to add additional lift and flight control, while and airfoils 18 become ailerons. Fuselage 12 may include winglets 82, 84 to reduce vortex shedding and thereby improve aerodynamic efficiency. To reduce drag, sliding or pivoting (bomb bay) doors may be employed to cover the retracted transition duct 48. Additionally, to reduce drag in horizontal flight mode, vertical flight gas diffuser 28 is retracted downward into fuselage 12.

Although certain illustrative embodiments and methods have been disclosed herein, it will be apparent from the foregoing disclosure to those skilled in the art that variations and modifications of such embodiments and methods may be made without departing from the invention. For example, although in the illustrative embodiment, the aircraft comprises a delta shaped fuselage, the inventive propulsion system may be used in combination with other airframes. Accordingly, it is intended that the invention should be limited only to the extent required by the appended claims and the rules and principles of applicable law. Additionally, as used herein, references to direction such as “up” or “down” as well as recited materials or methods of attachment are intended to be exemplary and are not considered as limiting the invention and, unless otherwise specifically defined, the terms “generally,” “substantially,” or “approximately” when used with mathematical concepts or measurements mean within ±10 degrees of angle or within 10 percent of the measurement, whichever is greater. As used herein, a step of “providing” a structural element recited in a method claim means and includes obtaining, fabricating, purchasing, acquiring or otherwise gaining access to the structural element for performing the steps of the method. As used herein, the claim terms are to be given their broadest reasonable meaning unless a clear disavowal of that meaning appears in the record in substantially the following form (“As used herein the term ______ is defined to mean ______”)

What is claimed is:

1. A vertical take off and landing (VTOL) aircraft comprising:
a fuselage comprising an aerodynamic lifting body having a top surface and a bottom surface;
an engine comprising a turbofan jet engine attached under the bottom surface of the fuselage, the engine having an air inlet and an exhaust outlet, the exhaust outlet exhausting a stream of hot gas in a rearward direction relative to the fuselage;
a vertical flight gas diffuser comprising a cylindrical duct having an open upper end extending from the top surface of the fuselage, the cylindrical duct having a plurality of exhaust apertures oriented radially outward for providing a flow of gas over the top surface of the fuselage to provide lift in a vertical flight mode;
a transition duct movable between at least a first, a second and a third position, the transition duct having an inlet which, in the first position, sealingly engages the exhaust outlet of the engine and directs the stream of hot gas through a 90° upward bend into the vertical flight diffuser, in the second position the transition duct partially engages the exhaust outlet of the engine and directs a portion of the stream of hot gas through a 90° upward bend into the vertical flight diffuser while allowing a portion of the stream of hot gas to be discharged rearward to provide a horizontal thrust component, and in the third position the transition duct engages no portion of the exhaust outlet of the engine, whereby the entirety of the engine thrust is directed rearward to propel the aircraft in a horizontal flight mode.

2. The aircraft of claim 1, further comprising:
a turbine disposed in the transition duct for extracting work from the stream of hot gas; and
a compressor driven by the turbine for drawing additional air into the vertical flight gas diffuser through the open upper end of the vertical flight gas diffuser.

3. The aircraft of claim 2, wherein:
the lifting body comprises a substantially delta-shaped lifting body having three lateral sides.

4. The aircraft of claim 3, further comprising:
a plurality of airfoils disposed along the three lateral sides, the airfoils operating to divert downward a flow of gas discharged from the vertical flight gas diffuser over the top surface of the lifting body in a vertical flight mode.

5. The aircraft of claim 4, wherein:
plural of the plurality of airfoils act as ailerons in a horizontal flight mode.

6. The aircraft of claim 4, wherein
plural of the plurality of airfoils act as canards in a horizontal flight mode.
